(19) United States
(12) Patent Application Publication
(10) Pub. No.: US 2025/0238767 A1
(43) Pub. Date: Jul. 24, 2025

(54) ROAD STRUCTURE MANAGEMENT SYSTEM AND NON-TRANSITORY STORAGE MEDIUM

(71) Applicant: TOYOTA JIDOSHA KABUSHIKI KAISHA, Toyota-shi (JP)

(72) Inventor: Yasutoshi OTA, Susono-shi (JP)

(73) Assignee: TOYOTA JIDOSHA KABUSHIKI KAISHA, Toyota-shi (JP)

(21) Appl. No.: 19/007,369

(22) Filed: Dec. 31, 2024

(30) Foreign Application Priority Data
Jan. 19, 2024 (JP) 2024-006852

(51) Int. Cl. G06Q 10/20; G06T 7/00; G06V 20/56

(52) U.S. Cl. CPC G06Q 10/20; G06T 7/0004; G06V 20/588; G06T 2207/30252

(57) ABSTRACT

A road structure management system comprising a server device comprising a processor for calculating a degree of damage to road structures based on data acquired from a vehicle, wherein the processor is configured to perform the following processing, obtaining detection values relating to the road structures that affect the travel of the vehicle traveling on the road structures which are detected by a detection unit provided in the vehicle, extracting damaged areas generated in the road structures based on a plurality of the detection values obtained from a plurality of the vehicles, calculating damage degree of the damaged area, in case of the level of the damage degree exceeds a predetermined criterion, and causing an output unit output a position information of the damaged area in the road structure.

### CROSS-REFERENCE TO RELATED APPLICATION

This application claims priority to Japanese Patent Application No. 2024-006852 filed on Jan. 19, 2024, which is incorporated herein by reference in its entirety.

### FIELD

The present invention relates to a road structure management system and a non-transitory storage medium capable of managing a road structure.

### BACKGROUND

Patent Document 1 (Japanese Patent Publication No. 2020-027086) describes a method in which a height of a road surface is measured while a vehicle is traveling by a measurement device mounted on the vehicle, and the road is managed based on the measurement data.

The measurement device described in Patent Document 1 is provided on an upper surface of a vehicle and includes a light projecting unit that projects a slit light downward, and an imaging unit that captures an image of the slit light projected onto the road surface.

In case of a road is managed by the measurement device described in Patent Document 1, a vehicle equipped with the measurement device must be constructed, and it is costly for measurement. In addition, in case of a road is managed by the measurement device described in Patent Document 1, it is necessary to periodically drive a vehicle for measurement, and labor for measurement is required.

An object of the present invention is to provide a road structure management system and a non-temporary storage medium capable of easily measuring a road structure and reducing labor required for measurement.

### SUMMARY

One aspect of the present invention is a road structure management system comprising a server device comprising a processor for calculating a degree of damage to road structures based on data acquired from a vehicle, wherein the processor is configured to perform the following processing, obtaining detection values relating to the road structures that affect the travel of the vehicle traveling on the road structures which are detected by a detection unit provided in the vehicle, extracting damaged areas generated in the road structures based on a plurality of the detection values obtained from a plurality of the vehicles, calculating damage degree of the damaged area, in case of the level of the damage degree exceeds a predetermined criterion, and causing an output unit output a position information of the damaged area in the road structure.

According to the present invention, it is possible to easily measure a road structure and to reduce labor required for measurement.

### BRIEF DESCRIPTION OF THE DRAWINGS

FIG. 1 is a block diagram illustrating a configuration of a road structure management system according to an embodiment.

FIG. 2 is a diagram illustrating an example of a road surface measurement method.

FIG. 3 is a diagram illustrating an example of a measurement area of a road surface.

FIG. 4 is a diagram illustrating an example of a display image for displaying a damaged area.

FIG. 5 is a flowchart illustrating a flow of processing of the road structure management method.

### DESCRIPTION OF EMBODIMENTS

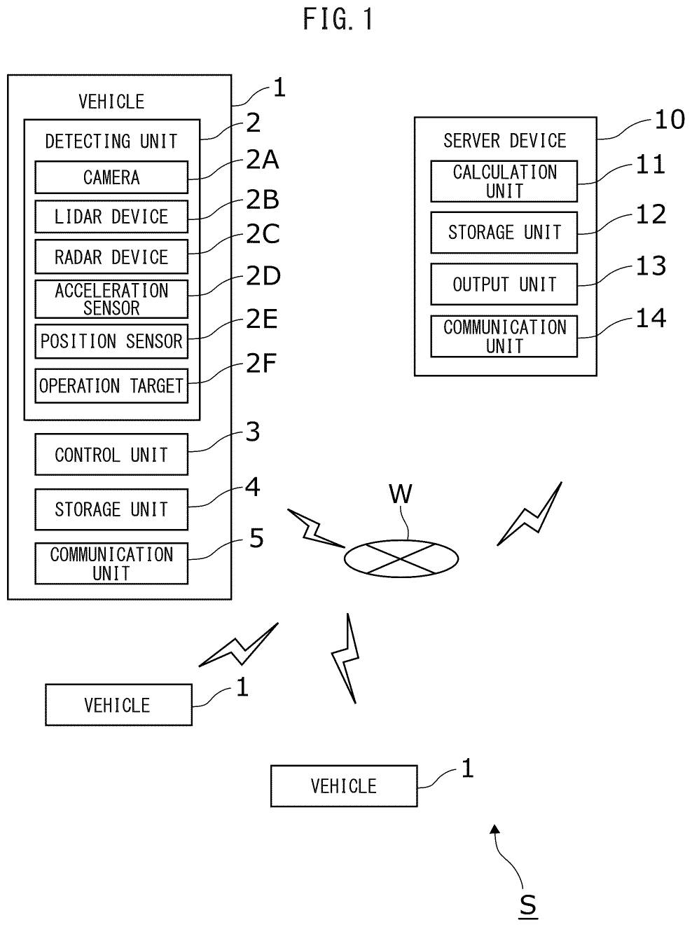

As illustrated in FIG. 1, the road structure management system S includes a plurality of vehicles 1 that can communicate with each other via a network W, and a server device 10. The road structure management system S acquires data detected by the vehicle 1, and the server device 10 calculates the degree of damage to the road structures based on the data. The road structure management system S is applied to the maintenance and management of the road structures by calculating the damage degree of the road structure. The road structure management system S manages whether an abnormality has occurred in the road structures by using the vehicle 1 traveling on the road. It is assumed that the user of the vehicle 1 subscribes to a road management service that transmits detection values detected by using the vehicle 1 to the server device 10.

The vehicle 1 includes a detecting unit 2 that detects data related to traveling. The configuration of the detecting unit 2 may be different for each vehicle 1. The detection values detected by the detecting unit 2 are used for driving assistance, a navigation device, or the like. The detecting unit 2 includes a camera 2A that captures images of the environments of the vehicle 1. The camera 2A outputs captured data of images of the surroundings of the vehicle 1. Imaging data of the camera 2A is used, for example, for driving assistance of the vehicle 1 and a drive recorder. The imaging area and the imaging direction of the camera 2A may differ depending on the vehicle 1.

The detecting unit 2 includes a LiDAR (Light Detection And Ranging) device 2B that detects three-dimensional datum around the vehicle 1. The LiDAR device 2B irradiates the front of the vehicle 1 or the periphery of the vehicle 1 with a laser beam at a constant cycle and measures the reflected light from objects around the vehicle 1. The LiDAR device 2B is configured to generate three-dimensional point cloud data around the vehicle 1 based on measurement data. The measured values of the LiDAR device 2B are used to detect other vehicles present around the vehicle 1, traffic participants such as pedestrians, bicycles, and motorcycles, and the objects present around the vehicle 1. Preferably, the LiDAR device 2B can detect the shape of the road surface as described below.

The detecting unit 2 includes a radar device 2C that detects the objects existing around the vehicle 1. The radar device 2C emits a millimeter-wave radar wave and receives reflected waves reflected by the object to detect a relative-distance with respect to the object. The detecting unit 2 includes an acceleration sensor 2D that detects an acceleration generated in the vehicle 1. The acceleration sensor 2D is, for example, a three-axis acceleration sensor generated in the front-rear direction, the left-right direction, and the up-down direction of the vehicle 1. The acceleration sensor 2D may be a six-axis acceleration sensor capable of further detection angular acceleration occurring in a rotational direction of a roll angle, a yaw angle, and a pitching angle occurring in the vehicle 1.

The detecting unit 2 includes a position sensor 2E that detects the present position of the vehicle 1. The position sensor 2E is, for example, a GPS (Global Positioning System) sensor or a GNSS (Global Navigation Satellite System) sensor. The detecting unit 2 may acquire operation amounts of the operation target 2F operated by the user as detection values. The operation target 2F is an operation input device for inputting an operation related to traveling of the vehicle 1, such as a steering wheel, a brake pedal, and an accelerator pedal. The detected values of the operation target 2F are the operation amounts obtained by the user operating the driving input device.

The vehicle 1 includes a control unit 3 that executes control related to traveling based on the detection values detected by the detecting unit 2. The control unit 3 integrates and executes control such as traveling, driving assistance, navigation, and communication with the server device 10 of the vehicle 1 based on the detected values. The vehicle 1 includes a storage unit 4 that stores data and programs. The control unit 3 is constituted by a hardware processor such as at least one CPU (Central Processing Unit). The storage unit 4 is constituted by a non-transitory storage medium such as a hard disk drive (HDD) or a solid-state disk (SSD). The storage unit 4 stores computer programs and data necessary for control.

The vehicle 1 includes a communication unit 5 capable of external communication. The communication unit 5 is constituted by a wireless communication device connectable to the network W. The control unit 3 stores the detection value detected by the detecting unit 2. The control unit 3 transmits the data of the detection value to the server device 10 via the network W at a predetermined timing. The control unit 3 may transmit the detection values to the server device 10 in case of it is determined that there is damage to the road structure while the vehicle 1 traveling on the road structure.

The control unit 3 compares the detection values detected by the detecting unit 2 with a preset threshold value and determines whether there are detection values related to the road structure that affect the travel of the vehicle 1. For example, in case of it is determined that a concave portion or a convex portion is present on the road surface based on the detection values of the LiDAR device 2B, the control unit 3 generates a road structure management data set including the detection values of the present position of the position sensor 2E and the detection values of the LiDAR device 2B, and stores the road structure management data set in the storage unit 4. The control unit 3 may generate the road structure-management data set in case of it is determined that the concave portion or the convex portion is present on the road surface based on the detected value of the acceleration-sensor 2D. The control unit 3 may generate the road structure-management data set in case of it is determined that there is an abnormality such as the presence of an object on the road surface based on the detected values of the radar device 2C.

In case of generating the road structure management data set including the detected values of the LiDAR device 2B, the radar device 2C, and the acceleration sensor 2D, the control unit 3 may extract the imaging data of the camera 2A at the corresponding road position and add it to the road structure management data set. The control unit 3 may be configured to extract an abnormality in the road structure based on the captured images of the camera 2A. The control unit 3 may be configured to extract an abnormality of the road structure captured in the imaging data, for example, based on supervised machine learning such as deep learning in advance.

The control unit 3 may extract not only the unevenness of the road surface but also wear of lane marks, road surface markings, and the like applied on the road surface. The road structure is not limited to a road surface and may be a structure associated with the road. The control unit 3 may extract an abnormality of a structure associated with a road, which affects the travel of the vehicle 1. The structures associated with the road include, for example, objects managed by a road administrator such as signs, signals, guardrails, bridge piers, and the like.

In case of determining the abnormality of the road structure based on the imaging data, the control unit 3 may add the imaging data to the road structure management data set. In case of an abnormality is found in the road structure, the user may operate the drive recorder to record the imaging data and may perform an operation of adding the imaging data to the road structure management data set. The control unit 3 may execute a measurement mode for measuring the road surface in case of the vehicle 1 being traveled satisfies a predetermined condition.

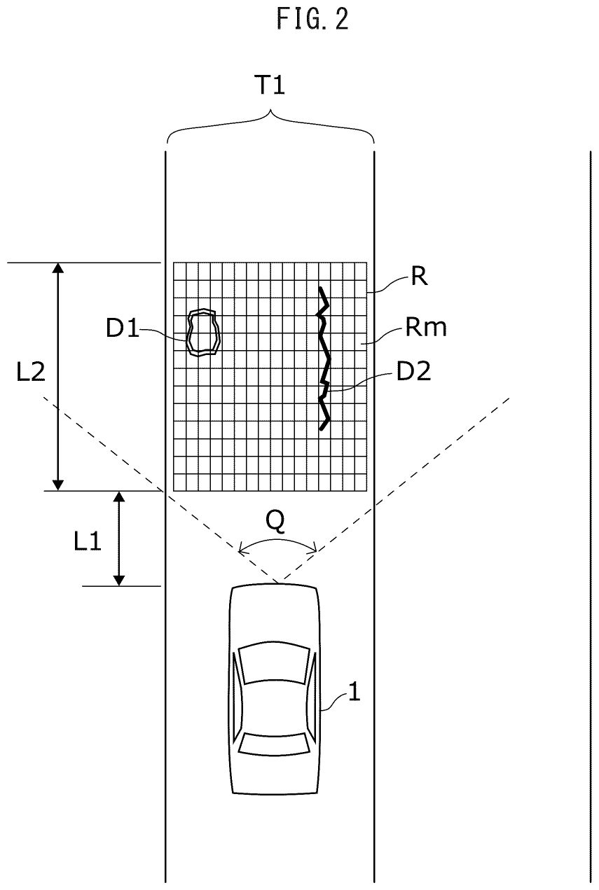

As shown in FIG. 2, the control unit 3 measures the road surface in the lane T1 on which the vehicles 1 travel in the measurement mode by the LiDAR device 2B. For example, in case of the vehicle 1 is traveling in the lane T1 and no other vehicle exists within a predetermined distance (for example, a 20-3 0m) in front of the vehicle 1, and in case of the speed of the vehicle 1 is equal to or less than a predetermined speed (for example, equal to or less than a 10 km/h), the control unit 3 executes the measurement mode. The velocity is set in accordance with the measurement accuracy of the LiDAR device 2B. The speed may be changed as long as the LiDAR device 2B can measure the road surface beyond the speed range. The control unit 3 measures the road surface using the LiDAR device 2B in the measurement mode. For example, the control unit 3 measures the measurement area R in the lane T1 in the illumination area Q of the LiDAR device 2B.

The measurement area R is set to a range of a predetermined measurement distance L2 from a point in the lane T1 that is equal to or larger than the closest distance L1 (e.g., 0.2-1 m) from the front of the vehicle 1. The measurement area R is divided into a plurality of rectangular measurement element Rm, for example, and coordinates are managed for each measurement element Rm. The measurement element Rm is set to a rectangle. The X direction (the left-right direction perpendicular to the lane T1) of the measurement element Rm is set to, for example, about 0.2-0.5 m corresponding to the tire-width based on the measurement accuracy of the LiDAR device 2B. The Y direction (the lane T1 direction, the traveling direction of the vehicle 1) of the measurement element Rm is set to about 0.2-1.0 m.

The control unit 3 calculates the mean value of the road surface based on the mounting height of the LiDAR device 2B, the dimension of the measurement area R, and the detected values. The control unit 3 extracts, based on the detected values, measurement points deviating in the vertical direction from the average values of the road surface. In the measurement area R, an abnormal portion such as a depressed portion D1 or a cracked D2 is detected to be recessed downward from the road surface. The abnormal portion may be such as a step protrude upward from the road surface. The measurement accuracy of the concave portion and the convex portion of the road surface may be on the order of cm units and is not necessarily measured precisely.

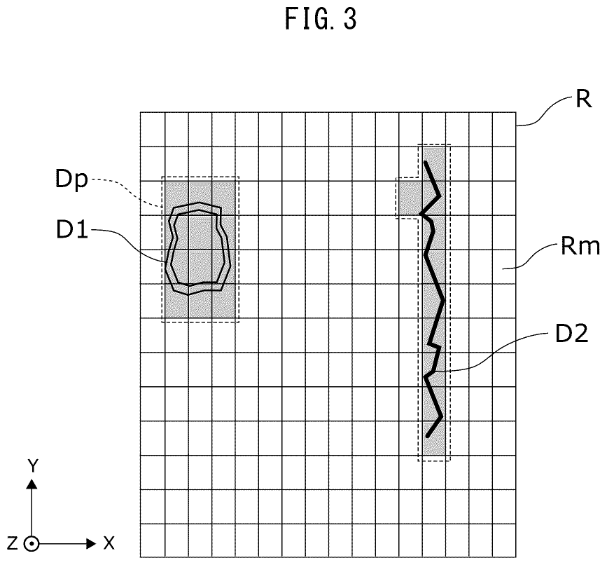

As illustrated in FIG. 3, the control unit 3 sets an abnormal area Dp (damaged area) including a plurality of measurement elements (small areas) corresponding to abnormal locations existing in the measurement area R. The control unit 3 divides the road structure into measurement elements of based on predetermined elements and extracts a plurality of measurement elements corresponding to the abnormal area Dp from among a plurality of divided measurement elements. The abnormal area Dp does not necessarily have to exactly correspond to the shapes thereof. The control unit 3 calculates the relative position of the abnormal area Dp based on the relative coordinates of the measurement elements Rm included in the abnormal area Dp. The control unit 3 calculates the absolute position of the abnormal area Dp based on the relative position of the abnormal area Dp and the detected values of the present position of the vehicle 1.

For example, the control unit 3 registers the calculated absolute position of the abnormal area Dp in the map-data stored in the storage unit 4. The measurement mode is executed by the plurality of vehicles 1. The measurement may be performed based on not only the LiDAR device 2B but also the captured image captured by the camera 2A. The measurement may be performed based on acceleration data measured by the acceleration sensor 2D. The control unit 3 may extract an abnormal portion of the structure associated with the road surface or the road based on the imaging data and the acceleration data. The control unit 3 may extract an object existing on the road based on the detected values. In this case, the object existing on the road is included in the abnormal area on the road.

After executing the measurement, the control unit 3 transmits a road-structure-management data set including the calculated absolute position of the abnormal area Dp to the server device 10. The calculated value of the absolute position of the abnormal area Dp includes, for example, the relative coordinates of the measurement elements Rm included in the abnormal area Dp and ID (latitude information, point information associated with longitude information, and the like), so that the data amount and the communication time of the road-structure-management data set transmitted to the server device 10 can be reduced.

For this reason, the server device 10 stores detection values including a plurality of road structure management data sets within a predetermined period such as weekly or monthly units. The server device 10 includes a communication unit 14 connectable to the network W. The communication unit 14 is configured by a communication interface capable of communicating with the vehicle 1 via the network W by wireless or wired communication. The server device 10 includes a storage unit 12 that stores data of detection values acquired from a plurality of vehicles 1. The server device 10 includes a calculation unit 11 that extracts the damaged area generated in the road structure based on data stored in the storage unit 12.

The calculation unit 11 is constituted by a hardware processor such as at least one CPU (Central Processing Unit). The storage unit 12 includes a non-transitory storage medium such as a hard disk drive (HDD) or a solid-state disk (SSD). The storage unit 12 stores computer programs and data necessary for control. The server device 10 includes an output unit 13 that outputs the damaged area in the road structure extracted by the calculation unit 11 and position information thereof. The output unit 13 is constituted by, for example, a display device such as a liquid crystal display.

The calculation unit 11 analyzes the plurality of road structure management data sets in case of the plurality of road structure management data sets stored in the storage unit 12 becomes equal to or larger than the predetermined number of samples in the predetermined period. The calculation unit 11 determines whether there is the damaged area of the road structure that affects the travel of the vehicle 1, based on statistical processing of the detection values equal to or larger than a predetermined number of samples in a predetermined period. For example, the calculation unit 11 determines whether the abnormal area Dp is the damaged area generated in the, based on a comparison between the average value of the data of the plurality of abnormal area Dp and a predetermined threshold value. The predetermined threshold value is set in advance by a value that affects the traveling of the vehicle 1, such as, for example, the height of the unevenness occurring on the road surface, the length of the crack occurring on the road surface, the degree of wear of the road surface marking, and the visibility of the marking. The calculation unit 11 calculates the level of the damage degree of the damaged area based on the determination result.

In case of the degree of damage exceeds a predetermined criterion, the calculation unit 11 determines that the abnormal area Dp is the damaged area. The calculation unit 11 extracts the damaged area based on the determination result. In case of the level of the degree of damage exceeds the predetermined criterion, the calculation unit 11 causes the output unit 13 to output the damaged area in the road structure and the position information thereof. The calculation unit 11 may determine the mode of damage to the damaged area based on the detection values of the predetermined number or more in the predetermined period. The damage mode is an attribute of damage corresponding to the road structure such as depression of the road surface, appearance of the step, formation of a rut, decrease of a bridge pier, deterioration of visibility of a sign based on tree or deterioration, and deterioration of visibility of a road surface sign.

The calculation unit 11 may determine the abnormality of the road structure based on imaging data captured by the camera 2A. The calculation unit 11 may be configured to extract the abnormality of a road structure captured in the imaging data, for example, based on supervised machine learning such as deep learning in advance. The calculation unit 11 may periodically monitor the road structure on a predetermined road based on the captured data aggregated from the plurality of vehicles 1, extract the damaged area in which the level of the degree of damage exceeds a predetermined reference, and output the damaged area and the position information of the damaged area on the road structure to the output unit 13.

The calculation unit 11 may execute the determination process of the measurement mode executed by the control unit 3 of the vehicle 1 based on the detection values. The calculation unit 11 and the control unit 3 may execute a part or all the determination processing in cooperation to extract the abnormality of the road structure. The calculation unit 11 may determine the abnormality of the road structure based on the detected values of the LiDAR devices 2B aggregated from the plurality of vehicles 1. The calculation unit 11 may determine the abnormality in the road structure based on the detected values of the radar devices 2C aggregated from the plurality of vehicles 1. The calculation unit 11 may determine the abnormality in the road structure based on the detected values of acceleration sensors 2D aggregated from the plurality of vehicles 1. The calculation unit 11 may determine the abnormality of the road structure based on a combination of one or more detection values.

The calculation unit 11 determines the level of the degree of damage according to the mode of damage of the damaged area. The calculation unit 11 may calculate an urgency degree for preserving the damaged area according to the level of the degree of damage. The calculation unit 11 may calculate a resource to be dispatched to the damaged area according to the calculated urgency. The calculation unit 11 calculates the resource according to the maintenance method, for example, in accordance with a mode of damage to the road structure such as repair of the road surface, repair of the structure, replacement of the structure, pruning of trees, re-coating of the road surface marking, and the like. The contents of the resource include, for example, information such as a construction period necessary for maintenance, contents of maintenance, necessary materials, costs, and personnel to be secured. The calculation unit 11 may cause the output unit 13 to output a display image including the urgency and the calculation result of the resource. In case of it is determined that the object is present on the road, the calculation unit 11 may increase the degree of urgency and output the result to the output unit 13 to promptly dispatch resources for collecting the object or sorting the traffic.

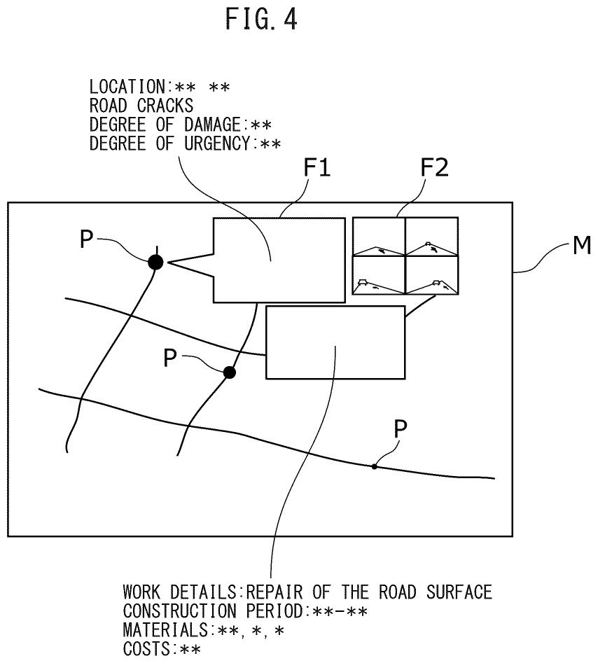

As illustrated in FIG. 4, the calculation unit 11 generates a display image M to be output to the output unit 13 based on the determination result. The display image M is generated based on, for example, map data. In the display image M, a damaged area P generated on the road is displayed. The damaged area P is displayed based on a visible display form such as a predetermined figure, a symbol, or the like. The display form of the damaged area P may be changed and displayed in accordance with the damage level. The damaged area P may be displayed with information related to the damage. In case of the user performs an information display operation such as clicking on the position of the damaged area P in the display image M, the calculation unit 11 displays information F1 related to the content of the damage and imaging data obtained by imaging the damaged area P.

The calculation unit 11 displays the degree of urgency for preserving the damaged area P in the display image M. The calculation unit 11 displays the contents of the resources to be dispatched to the damaged area according to the degree of urgency in the display image M. The road administrator can grasp the position and the damage level of the damaged area P based on the display image M, prepare the resource to be dispatched to the damaged area P, and set a maintenance plan for the damaged area P. In a case where the road structure is monitored by designating an arbitrary predetermined position by the road administrator, the road administrator may cause the user pass through the road including the predetermined position and collect the detection value.

The calculation unit 11 guides the user who is subscribed to the road management service to travel the road including the predetermined position by the vehicle 1 based on the input operation related to the information of the predetermined position and collects the detection values at the predetermined position. The calculation unit 11 may cause the vehicle 1 to execute the measurement mode on a road including a predetermined position. The calculation unit 11 may give an incentive such as giving points available for consumption activity to the user who provides the detection values at a predetermined position.

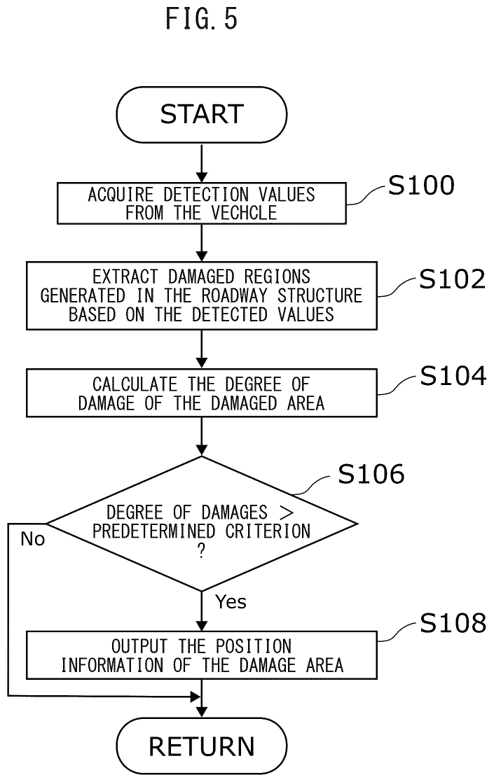

FIG. 5 shows a flow of processing of the road structure management method executed in the road structure management system S. The road structure management method is executed by a computer program installed in a computer installed in the server device 10. The road structure management method may be executed by the server device 10 and the vehicle 1 in cooperation with each other.

The calculation unit 11 acquires the detection values regarding the road structure that affects the travel of the vehicle 1, which is detected by the detecting unit 2 provided in the vehicle 1 (S100). The calculation unit 11 extracts damaged areas generated in the road structure based on the plurality of detected values acquired from the plurality of vehicles 1 (S102). The calculation unit 11 calculates the degree of damage of the extracted damaged area (S104). The calculation unit 11 determines whether the degree of damages exceeds the predetermined criterion (S106). In case of the level of the damage degree exceeds the predetermined criterion, the calculation unit 11 causes the output unit 13 to output the position information of the damage area in the road structure (S108).

As described above, according to the road structure management system S, since the detection values of the detecting unit 2 provided in the vehicle 1 are used, it is possible to easily measure the road structure and reduce the labor required for the measurement. According to the road structure management system S, since the detection values of the detecting unit 2 provided in the vehicle 1 are used, the measurement cost can be reduced as compared with a case where a vehicle for special measurement is provided. According to the road structure management system S, since the damaged area generated in the road structure is repeatedly measured by the plurality of vehicles 1 during a predetermined period, the influence of noise and measurement error can be reduced, and the reliability of the measurement result can be improved as compared with the case of using one measurement result. According to the road structure management system S, it is possible to quickly recover the damaged area by calculating a resource for preserving the damaged area.

1. A road structure management system comprising a server device comprising a processor for calculating a degree of damage to road structures based on data acquired from a vehicle, wherein the processor is configured to perform the following processing:
obtaining detection values relating to the road structures that affect the travel of the vehicle traveling on the road structures which are detected by a detection unit provided in the vehicle;
extracting damaged areas generated in the road structures based on a plurality of the detection values obtained from a plurality of the vehicles;
calculating damage degree of the damaged area; and
in case of the level of the damage degree exceeds a predetermined criterion, causing an output unit output a position information of the damaged area in the road structure.

2. The road structure management system according to claim 1, wherein the processor is configured to perform the following processing:
determining mode of damage of the damaged area based on the detected values of a predetermined number or more in a predetermined period; and
determining the degree of damage according to the mode of the damage.

3. The road structure management system according to claim 2, wherein the processor is configured to perform the following processing:
dividing the road structure into small areas of predetermined elements based on the detected values;
extracting a plurality of the small areas corresponding to the damaged area from the plurality of divided small areas; and
determining the mode of the damage in the damaged area.

4. The road structure management system according to claim 2, wherein the processor is configured to perform the following processing:
calculating a degree of urgency for preserving the damaged area according to the level of the damage degree according to the mode of the damage,
calculating resources to be dispatched to the damaged area according to the degree of urgency; and
causing the output unit to output the degree of urgency and calculation result of the resources.

5. A non-transitory storage medium in which a program for executing a road structure management method executed in a computer constituting a road structure management system is installed, wherein the program causes the computer to execute the following processing:
obtaining detection values relating to the road structures that affect the travel of the vehicle traveling on the road structures which are detected by a detection unit provided in the vehicle;
extracting damaged areas generated in the road structures based on a plurality of the detection values obtained from a plurality of the vehicles;
calculating damage degree of the damaged area; and
in case of the level of the damage degree exceeds a predetermined criterion, causing an output unit output a position information of the damaged area in the road structure.
